(19) United States
(12) Patent Application Publication
(10) Pub. No.: US 2020/0028810 A1
(43) Pub. Date: Jan. 23, 2020

(54) COGNITIVE RECOGNITION AND FILTERING OF CYBERBULLYING MESSAGES

(71) Applicant: International Business Machines Corporation, Armonk, NY (US)

(72) Inventors: John S. Werner, Fishkill, NY (US); Kavita Sehgal, Poughkeepsie, NY (US); Nicholas G. Danyluk, Long Island City, NY (US); Diane M. Stamboni, Poughkeepsi, NY (US); Sarah Wu, Kingston, NY (US); Sneha M. Varghese, Fishkill, NY (US)

(21) Appl. No.: 16/040,744

(22) Filed: Jul. 20, 2018

(51) Int. Cl. H04L 12/58; H04L 29/08; G06K 9/00

(52) U.S. Cl. CPC H04L 51/12; G06K 9/00302; H04L 51/046; H04L 67/306

(57) ABSTRACT

Aspects of the invention include identifying a user at an electronic device and accessing a profile of the user. The profile includes previously displayed data flagged as causing a negative reaction by the user when displayed to the user. New data for display is received at the electronic device. The new data is analyzed to determine whether it includes at least a subset of the previously displayed data flagged as causing a negative reaction by the user. The new data is displayed on a display of the electronic device based on determining that the new data does not include at least a subset of the previously displayed data flagged as causing a negative reaction. Otherwise, the new data is modified by removing the at least a subset of the previously displayed data from the new data and the modified data is displayed on the display of the electronic device.

### BACKGROUND

Embodiments of the present invention relate in general to using computer systems for electronic communication, and more specifically to cognitive recognition and filtering of cyberbullying messages.

With the increased use of electronic technology and an increasingly cyber-social society, cyberbullying has become increasingly common. Cyberbully refers to the use of electronic communication to bully a person, typically by sending messages of an intimidating or threatening nature. Examples of cyberbullying behavior include posting rumors, threats, or sexual remarks about a person, disclosing a victim's personal information, and/or posting pejorative labels (i.e., hate speech) via electronic forms of communication.

Cyberbullying can be difficult to recognize because attacks are often very specific to particular individuals. It has been estimated that as many as half of the children in grades four to twelve are victims of cyberbullying at one time or another, and that the majority of these cases go undetected by parents and schools. Parents or guardians may be unaware because they do not see all of the social media posts, text messages, and emails being sent to the individual that is being cyberbullied. Additionally, friends of an individual may be unaware the cyberbullying is taking place because the individual may be embarrassed and may not want to talk about it with others.

Accordingly, while computer systems for providing electronic communications are suitable for their intended purposes, what is needed are computer systems for providing electronic communications having certain features of embodiments of the present invention.

### SUMMARY

Embodiments of the present invention include methods, systems, and computer program products for cognitive recognition and filtering of cyberbullying messages. A non-limiting example method includes identifying a user at an electronic device and accessing a profile of the user. The profile includes previously displayed data flagged as causing a negative reaction by the user when displayed to the user. New data for display is received at the electronic device. The new data is analyzed to determine whether it includes at least a subset of the previously displayed data flagged as causing a negative reaction by the user. The new data is displayed on a display of the electronic device based on determining that the new data does not include at least a subset of the previously displayed data flagged as causing a negative reaction by the user. The new data is modified by removing the at least a subset of the previously displayed data from the new data and the modified data is displayed on the display of the electronic device based on determining that the new data includes at least a subset of the previously displayed data flagged as causing a negative reaction by the user.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a system for performing cognitive recognition and filtering of cyberbullying messages in accordance with one or more embodiments of the present invention;

FIG. 2 is a flow diagram of a process for building an emotion profile for a first user in accordance with one or more embodiments of the present invention;

FIG. 3 is a flow diagram of a process for determining data to be filtered in accordance with one or more embodiments of the present invention;

FIG. 4 is a flow diagram of a process for filtering data in accordance with one or more embodiments of the present invention;

FIG. 5 depicts a cloud computing environment according to one or more embodiments of the present invention;

FIG. 6 depicts abstraction model layers according to one or more embodiments of the present invention; and

FIG. 7 is a block diagram of a computer system for implementing some or all aspects of performing cognitive recognition and filtering of cyberbullying messages.

The diagrams depicted herein are illustrative. There can be many variations to the diagram or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

In the accompanying figures and following detailed description of the disclosed embodiments, the various elements illustrated in the figures are provided with two or three digit reference numbers. With minor exceptions, the leftmost digit(s) of each reference number correspond to the figure in which its element is first illustrated.

### DETAILED DESCRIPTION

One or more embodiments of the present invention automatically recognize and filter cyberbullying messages on an individual user basis. In addition, specified people, such as family and friends can be notified when it appears that an individual is being cyberbullied. One or more embodiments of the present invention capture facial expressions of a user while content is being displayed to the user at an electronic device to correlate facial expressions with content being viewed. This ability to determine what is upsetting to a particular user provides a more personal assessment of content that may indicate the user is being bullied when compared to contemporary techniques which assume that the same type of content is an indication of bullying for all users or a particular group of users (e.g., children).

One or more embodiments of the present invention detect negative emotional responses to screen content and take action depending on the policies that are in place. The action can include notifying a second person (e.g., a parent, a supervisor, law enforcement) about the content. The second person can be notified about a possible bullying situation and not given any further details about the content or source in order to maintain privacy between the first user and the second user. Alternatively, or in addition, the action can also include blocking or filtering future related incoming content or adding the current offending content, or document, to a collection of previously offending content so that analytics, or pattern recognition activity can be undertaken. Analysis of the previously offending content can be used for preemptive blocking of future content that shares similar characteristics (e.g., words, senders, etc.) with the offending content.

One or more embodiments of the present invention include a cognitive system that detects negative emotional responses when the user is reading a document (e.g., an email, a website, a social media site, text message, etc.) and determines if this is a recurring event that might indicate bullying behavior. The ability to assess whether content that is upsetting to the user is repeatedly received can be used to assess the likelihood that the user is being bullied and to identify the content that is upsetting to the user.

In accordance with one or more embodiments of the present invention an emotion baseline for a user is established using a camera facing the user while the user is at a user interface of an electronic device. The emotion baseline is established by learning the user's typical facial expressions and micro-expressions while using programs, or applications, on their electronic device. The camera can be a front-facing camera integrated into the electronic device such as those in contemporary laptop computers and smartphones, or it can be an external camera focused on the user. In one or more embodiments, a user's expressions are analyzed to detect emotions with negative reactions expressed via facial muscle movements (facial expressions or micro-expressions) to understand the user's inner emotions and triggers. When a negative reaction is detected, one or more embodiments of the present invention analyze what the user was reading and/or viewing on the electronic device and extract the information including, for example the content that caused the negative reaction and an identifier of the specific program displaying the content. The negative reaction can be an indication of cyberbullying and the content can be filtered out by one or more embodiments of the present invention when the user runs the program or alternative programs or application on the electronic device in the future.

One or more embodiments include optional settings (e.g., parental settings) that allow a second user (e.g., a parent, guardian, caretaker, psychologist, etc.) to receive a notification after a threshold amount of content is filtered for a user in order to provide awareness of the possible cyberbullying of the user. One or more embodiments of the processes described herein can be performed on a user's electronic device using a software program or application built in to an operating system or web browser of the electronic device. In other embodiments, the processes described herein are performed by a backend server in communication with the electronic device. In addition, the processes described herein can be executed in the background for every program executed on the user's electronic device or they can be executed only for specified programs executed on the user's electron device.

As described herein, emotions are detected through facial expressions which allow individuals to communicate social information with others verbally and non-verbally. A facial expression of a user can be correlated to an emotion such as, but not limited to: anger; contempt; disgust; fear; joy; sadness; and surprise. Emotions are referred to as universal emotions when they have the same or similar facial expressions associated with them irrespective of the age, religion, gender, language, etc. of the user. For example, a universal emotion of anger can be deduced based on a facial expression that includes, for example, eyebrows pulled down, upper eyelids pulled up, lower eyelids pulled up, margins of lips rolled in, and lips tightened. Other emotional state indicators are micro-expressions, that is the expressions that go on and off of the user's face in a fraction of a second, sometimes as fast as one thirtieth ( 1/30) of a second and are likely signs of concealed emotions.

In the human body the facial nerve controls the majority of facial muscles and hence, facial expressions. All muscles in the human body are innervated by nerves, which route all the way into the spinal cord and brain. The nerve connection is bidirectional, which means signals flow from brain-to-muscle and, at the same time, communicate information on the current muscle state back to the brain (muscle-to-brain). With facial expressions and emotional state of mind being intertwined, emotions can be captured and intelligently conveyed over computer programs.

One or more embodiments of the present invention determine a user's emotions using commercially available software that can determine an emotion of a user based on facial information captured by a camera. Examples of emotion recognition application programming interfaces (APIs) that can be utilized by one or more embodiments include, but are not limited to: IBM Watson® APIs from IBM such as Visual Recognition; EmoVu from Eyeris; and Insights from Nviso.

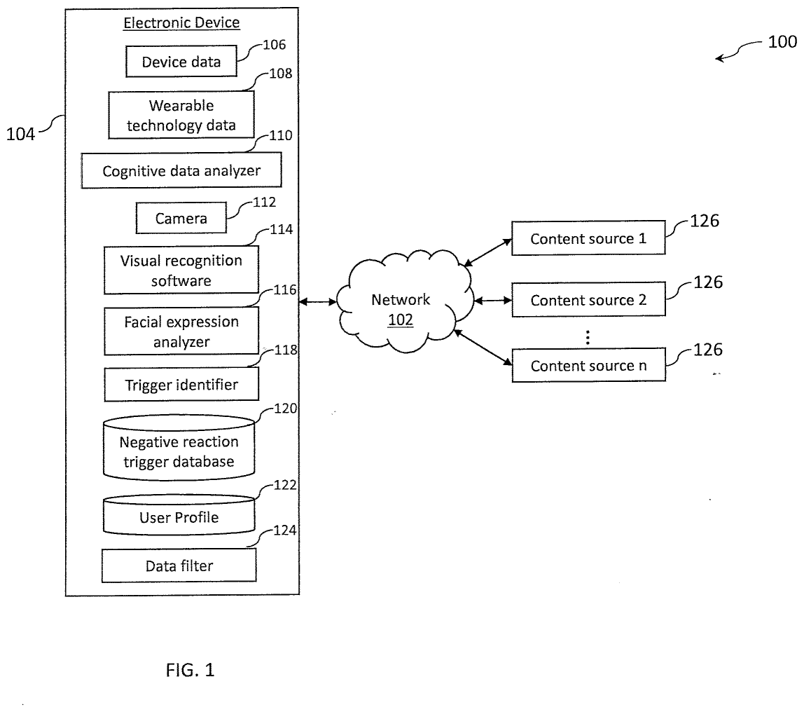

Turning now to FIG. 1, a system 100 for performing cognitive recognition and filtering of cyberbullying messages is generally shown in accordance with one or more embodiments of the present invention. As shown in the embodiment of FIG. 1, a an electronic device 104 interacts over a network 102 with content sources 126. The electronic device 104 can be implemented by any computer device known in the art such as, but not limited to: a mobile device; a laptop computer; a desktop computer; a smartphone; a tablet computer; and a smart television. The content sources 126 can include other people that the user receives text or email or other types of messages from. The content sources 126 can also include a server that hosts a messaging application such as, but not limited to: an email server; a messaging application server; a text message server; and a social media server. Example messaging applications include, but are not limited to, GroupMe® from Microsoft Corporation. Example text message servers include, but are not limited to, iMessage® from Apple Incorporated. Example social media servers include, but are not limited to: Facebook®, Twitter®, Instagram®, Snapchat®.

The electronic device 104 shown in FIG. 1 includes device data 106, wearable technology data 108, a cognitive data analyzer 110, a camera 112, visual recognition software 114, a facial expression analyzer 116, a trigger identifier 118, a negative reaction trigger database 120, a user profile 122, and a data filter 124. The cognitive data analyzer 110 executes on the electronic device 104 to analyze multiple sources of data. One source of data can be device data 106 which includes the text and images that are displayed on the electronic device 104. Another source of data that can be analyzed by the cognitive data analyzer 110 is wearable technology data 108 such as, but not limited to, a smart watch that measures the user's heart rate. Some embodiments of the electronic device 104 include wearable technology data 108, while other embodiments of the electronic device 104 do not include wearable technology data 108. A further source of data that can be analyzed by the cognitive data analyzer 110 is data, or images, from a built in camera 112. In other embodiments, the camera 112 is external to the electronic device 104. The camera 112 can monitor/capture the user's facial expressions while the electronic device 104 is in use and can be implemented, for example, by a camera built into a device (e.g., a camera on a cell phone), or a webcam (e.g., plugs into a laptop or desktop but is not directly built into the laptop or desktop). In one or more embodiments, data captured by an indoor security camera(s) that is stored on a cloud server can be accessed by cognitive data analyzer 110. In other embodiments (not shown) eye tracking data is also input and analyzed by the cognitive data analyzer 110.

Visual recognition software 114 and facial expression analyzer 116 can be implemented, for example, using the IBM Watson Visual Recognition API to extract expressions and micro-expressions from images captured by the camera 112 and to identify the user. In one or more embodiments of the present invention, the cognitive data analyzer 110 captures extracted information from all of the sources of data to build a user profile 122 for the user based on an association between their expressions and the device data that is displayed on a display of the electronic device. IBM Watson APIs such as, but not limited to: AlchemyLanguage, Natural Language Classifier, Natural Language Understanding, Personality Insights, Tone Analyzer, and/or Discover can be used to extract the context of what is shown on the first user's display. The data stored in the user profile 122 can include, but is not limited to: type of facial expressions; programs, or applications used; duration of the expression; duration of use of specific programs or applications; total duration of use; time of day that the user uses their devices; and/or type of typical expressions.

In one or more embodiments, the cognitive data analyzer 110 makes use of a trigger identifier 118 to detect when the user's expressions differ from the expected, or baseline, expressions that are established in the user's profile 122. The negative reaction trigger database 120 stores the device data 106 associated with negative reactions as detected by the facial expression analyzer 116 and the trigger identifier 118. As shown in FIG. 1, data filter 124 can be used to filter out or block future incoming data from the plurality of content sources 126 if the incoming data contains similar triggers that are stored in the negative reaction trigger database 120.

Though shown as all being contained in the electronic device 104 in the embodiment of the system 100 shown in FIG. 1, in alternate embodiments all or a portion of the components shown in the electronic device 104 of FIG. 1 can be physically located external to the electronic device 104. For example, all or a portion of the visual recognition software 114 can be located on a server and accessed via a network connection. In one or more embodiments of the present invention, the components shown in the electronic device 104 of FIG. 1 can be hosted on a backend server, for example Facebook may contain some of the components on their backend servers to filter negative/bullying posts to individual user profiles.

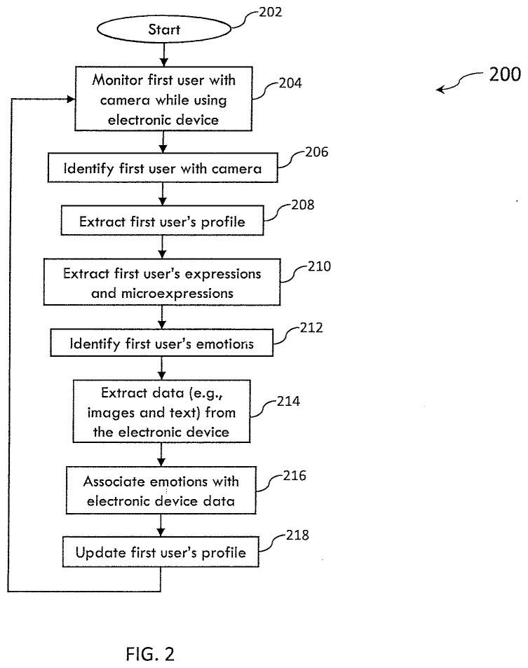

Turning now to FIG. 2, a flow diagram 200 of a process for building an emotion profile for a first user is generally shown in accordance with one or more embodiments of the present invention. The processing shown in FIG. 2 can be performed for example, by all or a portion of the cognitive data analyzer 110, visual recognition software 114, facial expression analyzer 116, and/or trigger identifier 118 of FIG. 1 executing on the electronic device 104 of FIG. 1. The process starts at block 202 when the user of an electronic device is detected, for example by detecting that a mobile device is unlocked or that a first user has logged into a desktop. At block 202 a camera, such as camera 112 of FIG. 1, is activated. At block 204, the first user is monitored with the camera while the first user is using the electronic device. Because a single device may be used by multiple people (e.g., an entire household), block 206 is performed to identify the person using the electronic device. The detected person, referred to herein as the first user, is identified using, for example, the camera and image recognition software, such as visual recognition software 114 of FIG. 1.

At block 208 of FIG. 2, a user profile, such as user profile 122 of FIG. 1, of the first user (the user identified at block 206) is extracted. The first user can be given the option to create a profile if one does not exist. Alternatively, the first user can be given the option to access a profile stored remotely, on a cloud server for example. At block 210, the first user's expressions and micro-expressions are extracted during the current use session. At block 212, the first user's emotions are identified using, for example, facial expression analyzer 116 of FIG. 1. At block 214, the device data, such as device data 106 of FIG. 1, displayed to the first user via a user interface of the electronic device is extracted from the electronic device. The extracted data can include text and image data. At block 216, the identified expressions are associated with extracted device data and stored in the first user's profile at block 218.

In one or more embodiments only data content associated with negative expressions/emotions are stored in the first user's profile to minimize storage space. In addition, the first user's profile can be updated continuously or periodically over time with new data about the first user to keep the first user's baseline up to date and to recognize any new cyberbullying trends that may emerge.

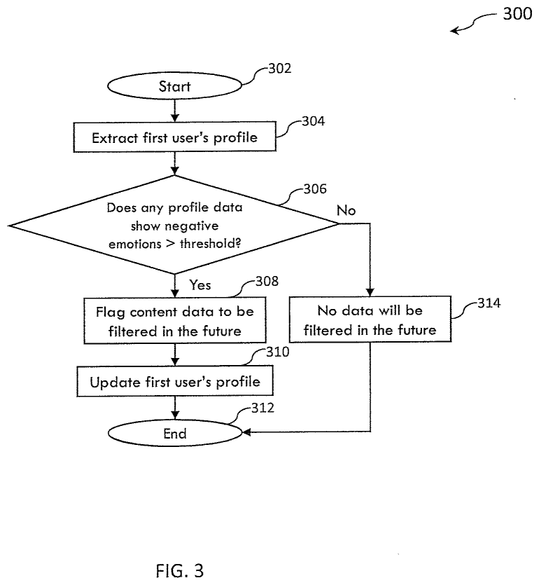

Turning now to FIG. 3, a flow diagram 300 of a process for determining data to be filtered is generally shown in accordance with one or more embodiments of the present invention. The processing shown in FIG. 3 can be performed for example, by all or a portion of the cognitive data analyzer 110 and the trigger identifier 118 of FIG. 1 executing on the electronic device 104 of FIG. 1. The process starts at block 302 and at block 304 the first user's profile, such as user profile 122 of FIG. 1, is accessed. At block 306 the first user's profile is analyzed to see if there is repeating data in which the first user showed negative expressions/emotions greater than a threshold number of times. The cognitive analysis at block 306 can also include using text analytics to analyze the negative data to differentiate between potential signs of bullying verses bad news (e.g., family member is in the hospital) such that only the potential signs of bullying are considered. The threshold number reflects a number of times that a negative reaction to a potential bullying post can be detected (e.g., three times, five times) before action is taken. The threshold number can be programmable by the first user or an administrator (e.g., parent of the first user). The content of new data may also affect the threshold at this decision block. For example, a threat may only need to be made one time to be flagged and a notification action may immediately be sent to a second user.

If it is determined at block 306, that the first user's profile data does not include particular content, or type of content, that has resulted in the first user showing a negative emotion more than the threshold number of times, then processing continues at block 314 and no data will be filtered in the future because there is no data in the first user's profile that indicates potential cyberbullying. Processing then ends at block 312.

If, as determined at block 306, that there is negative expression/emotion data in the first user's profile towards potential signs of bullying, the content data associated with the negative emotions is flagged at block 308 for future filtering. All flagged content data can be stored in the first user's profile at block 310, and processing ends at block 312.

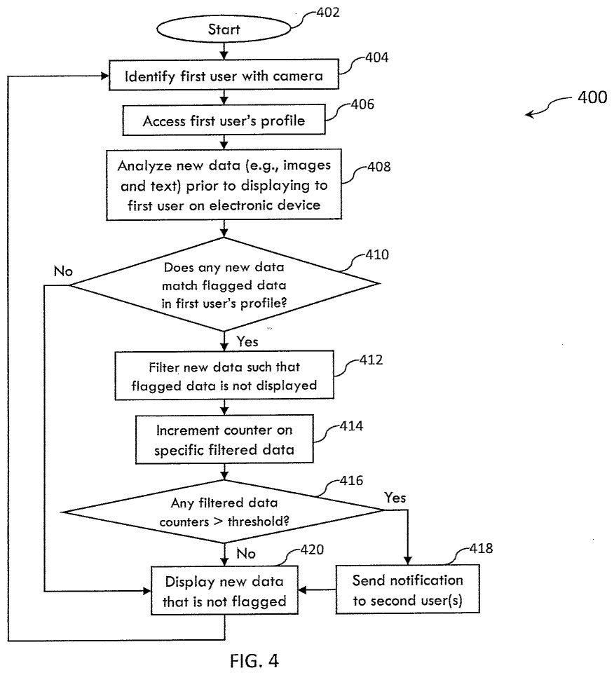

Turning now to FIG. 4, a flow diagram 400 of a process for filtering data is generally shown in accordance with one or more embodiments of the present invention. The processing shown in FIG. 4 can be performed for example, by all or a portion of the cognitive data analyzer 110 and the data filter 124 of FIG. 1 executing on the electronic device 104 of FIG. 1. The process starts at block 402, and at block 404, a first user is identified with a camera, such as camera 112 of FIG. 1. At block 406, the user profile, such as user profile 122 and negative reaction trigger database 120 of FIG. 1, of the first user is accessed. At block 408, new data (e.g., images, text, messages, graphics, etc.) received at the electronic device is analyzed prior to being displayed to the first user. In one more embodiments of the present invention an incoming message or the loading of a web page/application may be briefly delayed to perform all or a portion of the processing shown FIG. 4. In one or more embodiments of the present invention, the user may have to link or give approval to other applications (e.g., social media) to give them permission to analyze and potentially remove a message.

At block 410 of FIG. 4, the new data is compared to contents of the user profile of the first user to determine if it matches any flagged data. If it is determined that the new data does not match any flagged data in the first user's profile, then processing continues at block 420. If multiple people are bullying the user about certain content, the exact same wording may not be used every time by all the different people. In one or more embodiments more than simple text comparison is utilized to determine if the new data matches any flagged data. Text comparison can be supplemented with Watson APIs to extract keywords from the messages, to recognize the tone of the text, to recognize different tenses of keywords, and to recognize synonyms of the keywords, etc. For example, if a synonym of the flagged data is contained in the new data, then this may constitute a match between the flagged data and the subset of the new data containing the synonym.

Otherwise, if it is determined at block 410 that at least a portion of the new data matches any of the flagged data in the first user's profile, then block 412 is performed and the message is filtered, by data filter 124 of FIG. 1 for example. The filtering can include removing portions of the message, redacting portions of the message, or removing the entire message. In this manner the data that is displayed to the user is altered. At block 414, a counter in the first user's profile is incremented to keep track of the number of times that specific bullying content was sent to the first user's electronic device.

In one or more embodiments of the present invention, a threshold exists for the counters (e.g., 5 filtered messages relating to the same or similar content). If it is determined at block 416, that any of the filtered data counters have exceeded their threshold, then block 418 is performed and a second user is notified such that they are aware of the bullying issue and can offer assistance to the first user if needed. The threshold numbers can be programmable (e.g., by the first user, by a system administrator such as a guardian of the first user) and can be different for different types of content. The second user can be a parent of the first user, a guardian of the first user, a friend of the first user, a teacher of the first user, or any person selected by the first user. Alternatively, the second user may be set up in a parental controls menu on an electronic device that is given by parents to their kids or given by teachers to their students. Different types of notifications may exist and be triggered based on the counter such as notifications of awareness, notifications of information only, notifications for action, etc. After a notification is sent to a second user at block 418, processing continues at block 420 where the new data that is not flagged is displayed to the user. Processing continues at block 404.

If it is determined at block 416, that none of the filtered data counters have exceeded their threshold, then block 420 is performed and the new data that is not flagged is displayed to the first user. Processing continues at block 404.

When block 420 is performed after block 410 determines that none of the new data matches flagged data in the first user's profile, the new data is completely unfiltered because it contained no flagged data. When block 420 is performed after block 416 or 418, the new data may be partially filtered (e.g., redacted or removed) or the new data may not be displayed because the filtering process removed all of the data contents. The processing shown in FIG. 4 can be repeating as long as the electronic device is in use. In addition, the processing shown in FIG. 2 can be performed, followed by the processing shown in FIG. 3 to update the user's profile based on the new data displayed to the first user at block 420. In this manner, the first user's profile can continue to be updated based on new data.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

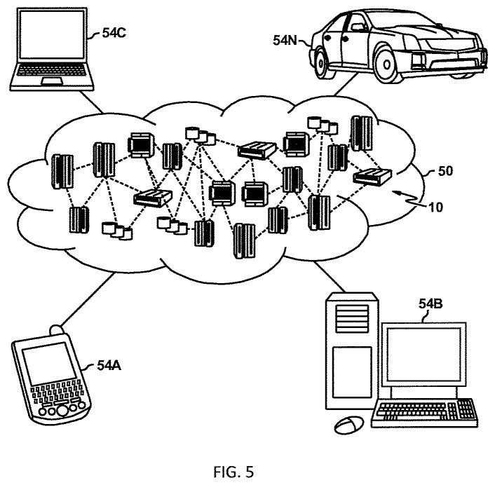

Referring now to FIG. 5, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 10 and cloud computing environment 50 can communicate with any type of computerized device over any type of network and/or network addressable connection (e.g., using a web browser).

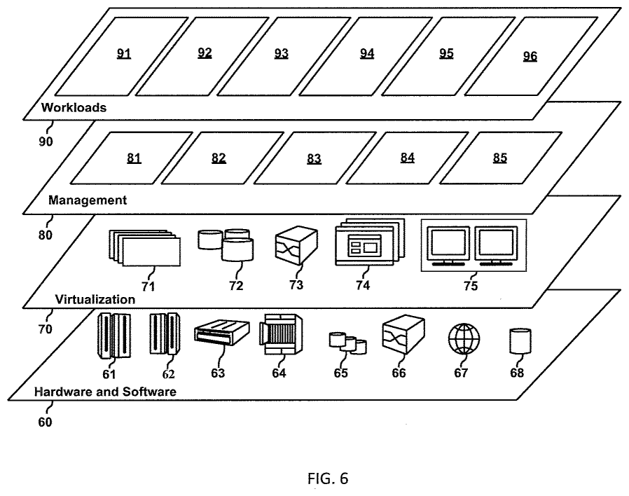

Referring now to FIG. 6, a set of functional abstraction layers provided by cloud computing environment 50 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and mobile desktop 96.

In accordance with one or more embodiments of the present invention, the system 100 shown in FIG. 1 is located in the cloud computing environment of FIG. 6 where all or a subset of the processing shown in FIGS. 2-4 is performed.

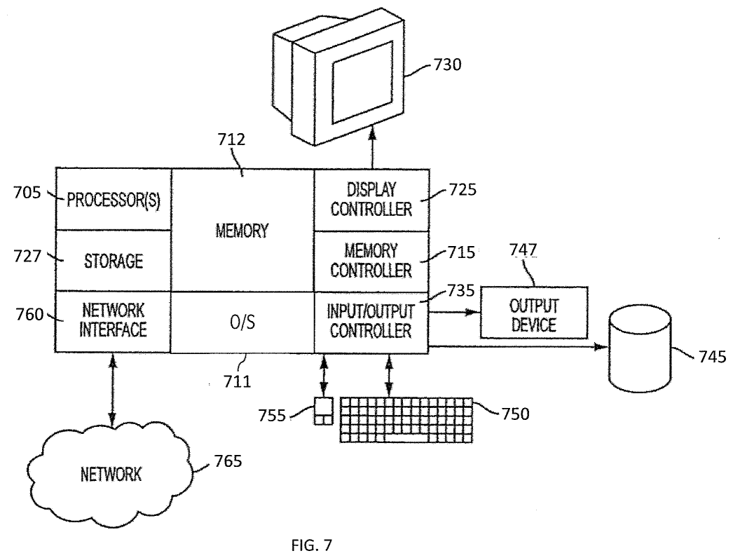

Turning now to FIG. 7, a block diagram of a computer system for implementing some or all aspects of providing cognitive recognition and filtering of cyberbullying messages is generally shown in accordance with one or more embodiments of the present invention. The processing described herein may be implemented in hardware, software (e.g., firmware), or a combination thereof. In an exemplary embodiment, the methods described may be implemented, at least in part, in hardware and may be part of the microprocessor of a special or general-purpose computer system, such as a mobile device, personal computer, workstation, minicomputer, or mainframe computer. In an embodiment the electronic device 104 of FIG. 1 is implemented by the computer system shown in FIG. 7.

In an exemplary embodiment, as shown in FIG. 7, the computer system includes a processor 705, memory 712 coupled to a memory controller 715, and one or more input devices 745 and/or output devices 747, such as peripherals, that are communicatively coupled via a local I/O controller 735. These devices 747 and 745 may include, for example, a printer, a scanner, a microphone, and the like. A conventional keyboard 750 and mouse 755 may be coupled to the I/O controller 735. The I/O controller 735 may be, for example, one or more buses or other wired or wireless connections, as are known in the art. The I/O controller 735 may have additional elements, which are omitted for simplicity, such as controllers, buffers (caches), drivers, repeaters, and receivers, to enable communications.

The I/O devices 747, 745 may further include devices that communicate both inputs and outputs, for instance disk and tape storage, a network interface card (NIC) or modulator/demodulator (for accessing other files, devices, systems, or a network), a radio frequency (RF) or other transceiver, a telephonic interface, a bridge, a router, and the like.

The processor 705 is a hardware device for executing hardware instructions or software, particularly those stored in memory 712. The processor 705 may be a custom made or commercially available processor, a central processing unit (CPU), an auxiliary processor among several processors associated with the computer system, a semiconductor based microprocessor (in the form of a microchip or chip set), a microprocessor, or other device for executing instructions. The processor 705 can include a cache such as, but not limited to, an instruction cache to speed up executable instruction fetch, a data cache to speed up data fetch and store, and a translation look-aside buffer (TLB) used to speed up virtual-to-physical address translation for both executable instructions and data. The cache may be organized as a hierarchy of more cache levels (L1, L2, etc.).

The memory 712 may include one or combinations of volatile memory elements (e.g., random access memory, RAM, such as DRAM, SRAM, SDRAM, etc.) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 712 may incorporate electronic, magnetic, optical, or other types of storage media. Note that the memory 712 may have a distributed architecture, where various components are situated remote from one another but may be accessed by the processor 705.

The instructions in memory 712 may include one or more separate programs, each of which comprises an ordered listing of executable instructions for implementing logical functions. In the example of FIG. 7, the instructions in the memory 712 include a suitable operating system (OS) 711. The operating system 711 essentially may control the execution of other computer programs and provides scheduling, input-output control, file and data management, memory management, and communication control and related services.

Additional data, including, for example, instructions for the processor 705 or other retrievable information, may be stored in storage 727, which may be a storage device such as a hard disk drive or solid state drive. The stored instructions in memory 712 or in storage 727 may include those enabling the processor to execute one or more aspects of the dispatch systems and methods of this disclosure.

The computer system may further include a display controller 725 coupled to a display 730. In an exemplary embodiment, the computer system may further include a network interface 760 for coupling to a network 765. The network 765 may be an IP-based network for communication between the computer system and an external server, client and the like via a broadband connection. The network 765 transmits and receives data between the computer system and external systems. In an exemplary embodiment, the network 765 may be a managed IP network administered by a service provider. The network 765 may be implemented in a wireless fashion, e.g., using wireless protocols and technologies, such as WiFi, WiMax, etc. The network 765 may also be a packet-switched network such as a local area network, wide area network, metropolitan area network, the Internet, or other similar type of network environment. The network 765 may be a fixed wireless network, a wireless local area network (LAN), a wireless wide area network (WAN) a personal area network (PAN), a virtual private network (VPN), intranet or other suitable network system and may include equipment for receiving and transmitting signals.

Systems and methods for cognitive recognition and filtering of cyberbullying messages can be embodied, in whole or in part, in computer program products or in computer systems, such as that illustrated in FIG. 7.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
identifying a user at an electronic device;
accessing a profile of the user, the profile comprising previously displayed data flagged as causing a negative reaction by the user when displayed to the user;
receiving new data for display at the electronic device;
analyzing the new data to determine whether it includes at least a subset of the previously displayed data flagged as causing a negative reaction by the user;
based on determining that the new data does not include at least a subset of the previously displayed data flagged as causing a negative reaction by the user, displaying the new data on a display of the electronic device; and
based on determining that the new data includes at least a subset of the previously displayed data flagged as causing a negative reaction by the user, modifying the new data by removing the at least a subset of the previously displayed data from the new data, and displaying the modified new data on a display of the electronic device.

2. The method of claim 1, further comprising:
sending a notification to a second user based on determining that the new data includes at least a subset of the previously displayed data flagged as causing a negative reaction to the user.

3. The method of claim 1, further comprising:
monitoring a reaction of the user when the new data is displayed on a display of the electronic device; and
updating the profile of the user based at least in part on the reaction being a negative reaction.

4. The method of claim 3, further comprising analyzing the data that caused the negative reaction using natural language processing to determine whether content of the data indicates potential bullying, wherein the updating is further based at least in part on the content of the data indicating potential bullying.

5. The method of claim 3, wherein a threshold number of negative reactions to data having content similar to the new data are recognized prior to updating the profile.

6. The method of claim 1, further comprising:
monitoring a reaction of the user when the new data is displayed on a display of the electronic device; and
updating the profile of the user based at least in part on the reaction.

7. The method of claim 6, wherein the monitoring comprises:
capturing, by a camera, an expression of the user while the new data is displayed on the display of the electronic device; and
analyzing the expression of the user to determine the reaction of the user.

8. The method of claim 7, wherein the monitoring further comprising capturing a micro-expression of the user while the new data is displayed on the display, and the micro-expression of the user is analyzed with the expression of the user to determine the reaction of the user.

9. The method of claim 1, wherein the identifying, accessing, receiving, analyzing, and displaying are performed by a software program built into an operating system or web browser of the electronic device.

10. The method of claim 1, wherein the identifying, accessing, receiving, analyzing, and displaying are performed by an application executing on the electronic device.

11. A system comprising:
a memory having computer readable instructions; and
one or more processors for executing the computer readable instructions, the computer readable instructions controlling the one or more processors to perform operations comprising:
identifying a user at an electronic device;
accessing a profile of the user, the profile comprising previously displayed data flagged as causing a negative reaction by the user when displayed to the user;
receiving new data for display at the electronic device;
analyzing the new data to determine whether it includes at least a subset of the previously displayed data flagged as causing a negative reaction by the user;
based on determining that the new data does not include at least a subset of the previously displayed data flagged as causing a negative reaction by the user, displaying the new data on a display of the electronic device; and
based on determining that the new data includes at least a subset of the previously displayed data flagged as causing a negative reaction by the user, modifying the new data by removing the at least a subset of the previously displayed data from the new data, and displaying the modified new data on a display of the electronic device.

12. The system of claim 11, wherein the operations further comprise:
sending a notification to a second user based on determining that the new data includes at least a subset of the previously displayed data flagged as causing a negative reaction to the user.

13. The system of claim 11, wherein the operations further comprise:
monitoring a reaction of the user when the new data is displayed on a display of the electronic device; and
updating the profile of the user based at least in part on the reaction being a negative reaction.

14. The system of claim 13, wherein the operations further comprise analyzing the data that caused the negative reaction using natural language processing to determine whether content of the data indicates potential bullying, wherein the updating is further based at least in part on the content of the data indicating potential bullying.

15. The system of claim 13, wherein a threshold number of negative reactions to data having content similar to the new data are recognized prior to updating the profile.

16. The system of claim 11, wherein the instructions further comprise:
monitoring a reaction of the user when the new data is displayed on a display of the electronic device; and
updating the profile of the user based at least in part on the reaction.

17. The system of claim 16, wherein the monitoring comprises:
capturing, by a camera, an expression of the user while the new data is displayed on the display of the electronic device; and
analyzing the expression of the user to determine the reaction of the user.

18. The system of claim 17, wherein the monitoring further comprising capturing a micro-expression of the user while the new data is displayed on the display, and the micro-expression of the user is analyzed with the expression of the user to determine the reaction of the user.

19. A computer program product comprising a computer readable storage medium having program instructions embodied therewith, the program instructions executable by a processor to cause the processor to perform operations comprising:
identifying a user at an electronic device;
accessing a profile of the user, the profile comprising previously displayed data flagged as causing a negative reaction by the user when displayed to the user;
receiving new data for display at the electronic device;
analyzing the new data to determine whether it includes at least a subset of the previously displayed data flagged as causing a negative reaction by the user;
based on determining that the new data does not include at least a subset of the previously displayed data flagged as causing a negative reaction by the user, displaying the new data on a display of the electronic device; and
based on determining that the new data includes at least a subset of the previously displayed data flagged as causing a negative reaction by the user, modifying the new data by removing the at least a subset of the previously displayed data from the new data, and displaying the modified new data on a display of the electronic device.

20. The computer program product of claim 19, wherein the operations further comprise:
sending a notification to a second user based on determining that the new data includes at least a subset of the previously displayed data flagged as causing a negative reaction to the user.
